(19) United States
(12) Patent Application Publication
(10) Pub. No.: US 2026/0160856 A1
(43) Pub. Date: Jun. 11, 2026

(54) COATING SYSTEMS, FILMS, AND ARTICLES FOR RADAR TRANSMISSION, METHODS OF MANUFACTURE AND USE THEREOF

(71) Applicant: PPG Industries Ohio, Inc., Cleveland, OH (US)

(72) Inventors: Eldon L. Decker, Gibsonia, PA (US); Scott J. Moravek, Mars, PA (US); Jason Lewis, Monaca, PA (US)

(73) Assignee: PPG Industries Ohio, Inc., Cleveland, OH (US)

(21) Appl. No.: 18/704,091

(22) PCT Filed: Oct. 5, 2022
(86) PCT No.: PCT/US2022/077594

§ 371 Date: Apr. 24, 2024

Related U.S. Application Data
(60) Provisional application No. 63/272,784, filed on Oct. 28, 2021.

(51) Int. Cl. G01S 7/02; C09D 7/40; C09D 7/61

(52) U.S. Cl. CPC G01S 7/027; C09D 7/61; C09D 7/67; C09D 7/70

(57) ABSTRACT

Coating systems, films, and articles with a metallic luster, and methods of manufacture and use thereof, are provided. The coating system comprises a first layer and a second layer disposed over at least a portion of the first layer. The first layer comprises a first film-forming resin and a first pigment. The CIELAB L* value of the first layer is no greater than 10. The second layer comprises a second film-forming resin, which is the same or different as the first film-forming resin, and a flake pigment. The contrast ratio of the second layer is no greater than 0.80. The coating system has a flop index of 19 or greater, such as, 20 or greater, 21 or greater, 22 or greater, 23 or greater, 24 or greater, 25 or greater, or 26 or greater.

### CROSS-REFERENCE TO RELATED APPLICATIONS

The present application claims priority to U.S. Provisional Application No. 63/272,784, titled “COATING SYSTEMS, FILMS, AND ARTICLES FOR RADAR TRANSMISSION, METHODS OF MANUFACTURE AND USE THEREOF”, filed Oct. 28, 2021, the entire contents of which is hereby incorporated by reference in its entirety.

### FIELD

Coating systems, films, and articles for radar transmission and methods of manufacture and use thereof are provided.

### BACKGROUND

The use of radar is becoming ubiquitous in modern transportation including passenger vehicles with advanced driver assistance systems (ADAS), such as adaptive cruise control (ACC), automatic breaking, and the like. The use of radar will likely increase as further advances in autonomous driving are implemented. However, radar performance can be hindered by unwanted radar signal loss that may result from the use of metallic pigments, such as aluminum flakes, that are commonly used in coatings to achieve certain desirable appearance properties, such as luster, sparkle, and/or metallic color.

### SUMMARY

The present disclosure relates to a coating system comprising a first layer and a second layer disposed over at least a portion of the first layer. The first layer comprises a first film-forming resin and a first pigment. The CIELAB L* value of the first layer is no greater than 10, such as, no greater than 8, no greater than 6, no greater than 5, no greater than 3, or no greater than 2, as measured with an integrating sphere spectrophotometer with D65 Illumination, 10° observer, and specular component excluded (SCE). The second layer comprises a second film-forming resin, which is the same or different as the first film forming resin, and a flake pigment. The contrast ratio of the second layer is no greater than 0.80, such as, no greater than 0.70, no greater than 0.60, no greater than 0.50, no greater than 0.40, or no greater than 0.38, as measured using an integrating sphere spectrophotometer with D65 illumination, 10° observer, and specular component included. The coating system has a flop index of 19 or greater, such as, 20 or greater, 21 or greater, 22 or greater, 23 or greater, 24 or greater, 25 or greater, or 26 or greater, as measured using a multi-angle spectrophotometer, with D65 illumination and 10° observer according to the following equation:

$$Flop Index = 2.69 {( {L}_{15} - {L}_{110} )}^{1.11} / {( {L}_{45} )}^{0.86}$$

wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°.

It is understood that the this disclosure is not limited to the examples summarized in this Summary. Various other aspects are described and exemplified herein.

### DETAILED DESCRIPTION

The present disclosure is directed to coating systems, films, and articles for radar transmission and that have a desirable appearance property, such as luster, sparkle, flop index, and/or metallic color. Metallic pigments, such as aluminum flakes, are commonly used in coatings as effect pigments to achieve a desirable luster, sparkle, flop index, and/or a metallic color. However, the use of metallic effect pigments in a coating can lead to a loss in radar transmission through the coating. Additionally, removal of the metallic pigment can increase radar transmission through the coating at the expense of the desirable luster, sparkle, flop index, and/or metallic color. Therefore, the present disclosure provides a coating composition that can achieve a desirable luster, sparkle, flop index, and/or metallic color with minimal, if any, radar transmission loss through a coating comprising a pigment. The coating composition according to the present disclosure comprises a first layer and a second layer. The first layer comprises a film-forming resin, a first pigment, and a CIELAB L* value of no greater than 10 as measured with an integrating sphere spectrophotometer with D65 Illumination, 10° observer, and SCE. The second layer comprises a film-forming resin, a flake pigment, and a contrast ratio of no greater than 0.80. The coating system has a flop index of 19 or greater.

The lightness value of a coating can be measured and quantified at various angles and reported using the CIELAB L* values of a coating system, film, and/or article using the International Commission on Illumination (CIE) L* value as discussed here. CIE L*a*b* (CIELAB) color values can be measured using a multi-angle spectrophotometer, such as a BYKmac I, from Altana, at the measurement angles of 15°, 25°, 45°, 75°, and/or 110° relative to the specular direction, with D65 illumination and 10° observer. As used herein, L₁₅ refers to the L* lightness value at the measurement angle of 15°, L₂₅ refers to the L* lightness value at the measurement angle of 25°, L₄₅ refers to the L* lightness value at the measurement angle of 45°, L₇₅ refers to the L* lightness value at the measurement angle of 75°, and Luo refers to the L* lightness value at the measurement angle of 110°. As used herein, the Near Specular Lightness Test quantifies the lightness value of a coating using the L₁₅ value, which can be measured using a multi-angle spectrophotometer, such as a BYKmac I, from Altana, at the measurement angle of 15°, relative to the specular direction, with D65 illumination and 10° observer.

In other instances, the lightness value of a coating can be measured and quantified using an integrating sphere spectrophotometer, such as an X-rite CI7800, with D65 illumination and 10° observer, with specular component included (SCI) or specular component excluded (SCE).

The coating composition according to the present disclosure comprises a first layer and a second layer. The first layer comprises a film-forming resin, a first pigment, and a CIELAB L* value of no greater than 10 as measured with an integrating sphere spectrophotometer with D65 Illumination, 10° observer, and SCE. The second layer comprises a second film-forming resin, which is the same or different as the film forming resin used in the first layer, and a flake pigment. The contrast ratio of the second layer is no greater than 0.80, as measured using an integrating sphere spectrophotometer with D65 illumination, 10° observer, and specular component included.

A film-forming resin can include a resin that can form a self-supporting (e.g., able to remain as a film of material with defined thickness, length and width and remains so without a supporting substrate being present) continuous film upon removal of any diluents or carriers during physical drying and/or cure at ambient or elevated temperature. “Film-forming resin” as used herein refers to resins that are self-crosslinking, resins that are crosslinked by reaction with a crosslinker, forming a solid film by solvent evaporation, mixtures thereof, or the like. The term “film-forming resin” can refer collectively to both a resin and crosslinker therefor.

The film-forming resin can comprise a thermosetting film-forming resin and/or a thermoplastic film-forming resin. As used herein, the term “thermosetting” refers to resins that “set” irreversibly upon curing or crosslinking, where the polymer chains of the polymeric components are joined together by covalent bonds, which are often induced, for example, by heat or radiation. In various examples, a curing or crosslinking reaction can be carried out under ambient conditions (e.g., approximately 20 to 25° C. and/or 1 atmosphere of pressure). Once cured or crosslinked, a thermosetting film-forming resin may not melt upon the application of heat and can be insoluble in conventional solvents (e.g., less than 0.001 g of the material can dissolve in 1 g of the given solvent at 20° C. after 24 hours). As used herein, the term “thermoplastic” refers to resins that include polymeric components that are not joined by covalent bonds and thereby can undergo liquid flow upon heating and are soluble in conventional solvents (e.g., at least 0.1 g of the material can dissolve in 1 g of the given solvent at 20° C. after 24 hours).

Thermosetting coating compositions may include a crosslinking agent that may be selected from, for example, aminoplasts, polyisocyanates (including blocked isocyanates), polyepoxides, beta-hydroxyalkylamides, polyacids, anhydrides, organometallic acid-functional materials, polyamines, polyamides, and mixtures of any of the foregoing.

A film-forming resin may have functional groups that are reactive with the crosslinking agent. The film-forming resin in the coatings described herein may be selected from any of a variety of polymers well known in the art. The film-forming resin may be selected from, for example, acrylic polymers, epoxy polymers, polyester polymers, polyurethane polymers, polyamide polymers, polyether polymers, polysiloxane polymers, copolymers thereof, and mixtures thereof. Generally, these polymers may be any polymers of these types made by any method known to those skilled in the art. The functional groups on the film-forming resin may be selected from any of a variety of reactive functional groups, including, for example, carboxylic acid groups, amine groups, epoxide groups, hydroxyl groups, thiol groups, carbamate groups, amide groups, urea groups, isocyanate groups (including blocked isocyanate groups), mercaptan groups, or combinations thereof.

The first pigment of the first layer can be radar transmissive. As used herein, “radar transmissive” in reference to a pigment, means the pigment minimally, if at all, inhibits transmission of electromagnetic radiation at radar frequency wavelengths.

The first pigment can be configured to achieve a desirable dark color of the first layer. The dark color can be measured by the CIELAB L* SCE and/or the jetness of the first layer. For example, the CIELAB L* SCE value of the first layer can be no greater than 10 as measured with an integrating sphere spectrophotometer with D65 Illumination, 10° observer, and SCE, such as, for example, no greater than 8, no greater than 6, no greater than 5, no greater than 3, or no greater than 2, as measured with an integrating sphere spectrophotometer with D65 Illumination, 10° observer, and SCE. The first layer can comprise a jetness of 350 or greater as measured at 110°, using a multi-angle spectrophotometer, with D65 illumination and 10° observer, such as, for example, 360 or greater, 370 or greater, or 380 or greater, all as measured at 110°, using a multi-angle spectrophotometer, with D65 illumination and 10° observer. Jetness can be measured according to Equation 12 from K. Lippok-Lohmer, “Praxisnahe Schwarzmessungen,” Farbe+Lack, 92 (1986) 1024-1029, which discloses Jetness=100×{[log₁₀(Xₙ/X)+log₁₀(Yₙ/Y)−log₁₀(Zₙ/Z)]}, which is hereby incorporated by reference.

The first pigment can be a single pigment or a mixture of different pigments. The first pigment can comprise carbon black, iron oxide, perylene black, Pigment Blue 15:1, Pigment Blue 15:3, Pigment Brown 25, Pigment Red 101, Pigment Red 179, Pigment Red 202, Pigment Red 257, Pigment Red 264, Pigment Violet 19, Pigment Violet 29, Pigment Yellow 129, Pigment Yellow 139, Pigment 150, Pigment yellow 42, or a combination thereof. The first pigment can comprise a nano-sized pigment having an average particle size of less than 100 nm, such as, for example, less than 50 nm or less than 40 nm as measured with a transmission electron microscope (TEM). As used herein, average particle size measured with a TEM refers to the Feret diameter of the particle as measured by TEM.

The first pigment can comprise a transmission haze of no greater than 10% as measured according to ASTM D1003, such as, for example, no greater than 8%, no greater than 4%, no greater than 3%, no greater than 2%, or no greater than 1%, all as measured according to ASTM D1003 with a spectrophotometer such as, for example, an X-rite Ci7800. For example, to measure the transmission haze, a suitable amount (e.g., 0.04% by weight based on the total weight of the dispersion) of the first pigment of the first layer can be dispersed and diluted into a suitable solvent such as n-butyl acetate and placed in an optical cell of a spectrophotometer. The transmission haze is a measurement of electromagnetic radiation that is subject to scattering at an angle of greater than 2.5 degrees at a maximum absorbance of the pigment within the visible wavelength range of 400 to 700 nm and having a percent transmittance in a range of 15 percent to 20 percent, such as, for example, 17.5 percent. The transmission haze can be measured according to U.S. Pat. No. 6,875,800, filed Jun. 7, 2002, and the transmission measurement procedure of U.S. Pat. No. 6,875,800, filed Jun. 7, 2002, which is hereby incorporated by reference.

A first coating composition used to form the first layer, and/or the first layer can comprise the first pigment in an amount, for example, in a range of 0.5 volume % (vol %) to 70 vol %, such as, for example, 1 vol % to 60 vol %, based on total volume of a first layer formed from the first coating composition.

The second layer of the coating system can be disposed over at least a portion of the first layer. The second layer may comprise a film-forming resin that may be the same or different as the film forming resin of the first layer, described herein, and a flake pigment. The flake pigment may be configured such that the second layer may be radar transmissive. For example, because the flake pigment is significantly transparent (e.g., transmits 80% or greater of electromagnetic radiation comprising a frequency of 1 GHz to 300 GHz) to radar signals, the second layer is also significantly transparent to radar signals.

As used herein, the term “flake pigment” means pigment that is flake shaped, where the ratio of the width of the pigment to the thickness of the pigment (termed aspect ratio) is at least 5, such as, for example, at least 6, at least 10, at least 100, at least 200, at least 500, or at least 1,000. The aspect ratio of flake pigment can be less than 2,000, such as, for example, less than 1,000, less than 500, less than 200, less than 100, less than 10, or less than 6. The aspect ratio of the flake pigment can be in the range of 5 to 2,000, such as, for example, 5 to 1,000, 10 to 2,000, 10 to 200, or 20 to 500. The flake pigment can comprise a thickness of less than 10 microns as measured by TEM, such as, for example, less than 5 microns, less than 0.5 microns, or less than 0.05 microns, all measured by TEM. The flake pigment can comprise a thickness greater than 0.05 microns as measured by TEM, such as, for example, greater than 0.5 microns, greater than 5 microns, or greater than 10 microns all measured by TEM. The flake pigment can comprise a thickness in a range of 0.05 microns to 10 microns as measured by TEM, such as, for example, 0.5 to 5 microns as measured by TEM. The flake pigment can comprise a width of less than 150 microns as measured by TEM, such as, for example, less than 30 microns, less than 20 microns, less than 10 microns, less than 5 microns, or less than 2 microns all measured by TEM. The flake pigment can comprise a width of greater than 1 micron as measured by TEM, such as, for example, greater than 2 microns, greater than 5 microns, greater than 10 microns, greater than 20 microns, greater than 30 microns, or greater than 150 microns all measured by TEM. The flake pigment can comprise a width in a range of 1 to 150 microns as measured by TEM, such as, for example, 5 to 30 microns or 10 to 15 microns, all measured by TEM.

The flake pigment of the second layer can comprise a single pigment or a mixture of different pigments. The flake pigment can comprise, for example, mica pigment, oxide coated mica pigment, glass flake, oxide coated glass flake, visible light diffractive pigment, visible light reflective organic pigment, metal oxide platelets, radar transmissive composite pigments, or a combination thereof. For example, the visible light diffractive pigment can comprise ordered arrays of particles in a polymeric matrix, such as, for example, the color effect pigments described in U.S. Pat. No. 6,894,086 to Munro et al. and the colorant described in U.S. Pat. No. 8,133,938 to Munro et al. The description of the color effect pigment in U.S. Pat. No. 6,894,086 to Munro et al and the description of the colorant in U.S. Pat. No. 8,133,938 to Munro et al. are hereby incorporated by reference. The visible light reflective organic pigment can comprise polymeric layers, such as, for example, the pigments described in U.S. Pat. No. 6,299,979 to Neubauer et al., which is hereby incorporated by reference. The metal oxide platelets can be, for example, aluminum oxide and titanium oxide. A radar transmissive composite pigment can comprise the non-conductive composite according to PCT/US2021/040877 entitled “RADAR TRANSMISSIVE PIGMENTS, COATINGS, FILMS, ARTICLES, METHODS OF MANUFACTURE THEREOF, AND METHODS OF USE THEREOF”, filed Jul. 8, 2021. The description of the non-conductive composite in PCT/US2021/040877 is hereby incorporated by reference. The flake pigment can comprise a non-conductive pigment according to PCT/US2020/045430 entitled “COATING COMPOSITIONS, LAYERS, and SYSTEMS FOR RADAR TRANSMISSION AND METHODS FOR MAKING AND USING THE SAME” filed Aug. 7, 2020. The description of the non-conductive pigment in PCT/US2020/045430 is hereby incorporated by reference. A second coating composition used to form the second layer, and/or the second layer can comprise the flake pigment in an amount, for example, in a range of 0.5 vol % to 60 vol %, such as, for example, 1 vol % to 50 vol % or 2 vol % to 25 vol %, based on total volume of a second layer formed from the coating composition.

The second layer may not be completely hiding, as discussed below, due to the configuration of the flake pigment. For example, the flake pigment may be less hiding than comparable metallic effect pigments. Therefore, the contrast ratio of the second layer may be no greater than 0.80 as measured using an integrating sphere spectrophotometer with D65 illumination, 10° observer, and SCI, such as, for example, no greater than 0.70, no greater than 0.60, no greater than 0.50, no greater than 0.40 or no greater than 0.38, as measured using an integrating sphere spectrophotometer with D65 illumination, 10° observer, and SCI.

The contrast ratio can be measured according to the Contrast Ratio Test. The Contrast Ratio Test comprises applying a coating layer, a coating system, and/or a film onto a standard panel for measuring the hiding power of a coating layer, a coating system, and/or a film (i.e., Form T12G METOPAC™ Panel, 3×5× 3/16 inch, available from Leneta Company, Inc. Mahwah, New Jersey). The standard panel has a black portion with an L* of 26 (+/−5%) and a white portion having an L* of 94 (+/−5%) measured with an integrating sphere spectrophotometer, such as, for example, an X-Rite CI7800, with D65 illumination, 10° observer, and SCI. After coating the panel with a coating layer, a coating system, and/or a film to be measured for opacity, the L₁₁₀ is measured over the black and white portions of the standard panel with a multi-angle spectrophotometer, such as, for example, a BYKmac I multi-angle spectrophotometer, with D65 illumination and 10° observer. A ratio of the L₁₁₀ values measured over the black and white portions of the coated standard panel is then determined, which quantifies the contrast ratio of the coating layer, the coating system, and/or the film. The equation for the contrast ratio is set forth in Equation 1 below:

$$Contrast Ratio = {L}_{110} ( over the black portion of the panel ) / {L}_{110} ( over the white portion of the panel ) \qquad Equation 1$$

The first pigment of the first layer can be incorporated into the first coating composition and/or the flake pigment of the second layer can be incorporated into the second coating composition by grinding or simple mixing.

The coating system according to the present disclosure can provide a desirable luster, sparkle, flop index, and/or metallic color, and minimize reduction of radar transmission as compared to coating systems that wholly incorporate electrically conductive metallic effect pigments, such as, for example, aluminum flake, copper flake, silver flake, silver-coated copper flake, nickel flake, or other metallic flakes. Coating systems that wholly incorporate electrically conductive metallic effect pigments have an electrical resistivity significantly lower than the flake pigment of the present disclosure, such as, for example, seven orders of magnitude lower (such as 10⁻⁶ Ohm cm), which can result in a high radar transmission loss. Because the coating system according to the present disclosure substantially comprises radar transmissive pigment, the coating system can enable the efficient transmission of electromagnetic radiation, including radar frequency wavelengths. For example, the coating system according to the present disclosure and/or films, and/or articles that incorporate the coating system can enable efficient transmission of electromagnetic radiation in a wavelength in a range of 1 GHz to 300 GHz, such as, for example, 1 GHz to 100 GHz or 76 GHz to 81 GHz. The 76 GHz to 81 GHz wavelength range can be utilized for automotive radar and other radar applications. The coating systems according to the present disclosure, and/or films and/or articles that incorporate the coating system can enable the efficient transmission of (e.g., are transparent to) electromagnetic radiation at a wavelength frequency of 24 GHz, 76 GHz, 77 GHz, and/or 81 GHz.

While reducing an electrically conductive metallic effect pigment concentration in the second layer can minimize the reduction of radar transmission of the coating system, there is a risk that the coating system may also have a reduced luster, sparkle, flop index, and/or metallic color. This is so because other radar transmissive pigments (e.g., mica) have less of a luster, sparkle, flop index, and/or metallic color than a comparable electrically conductive metallic effect pigment. However, the L* value and/or jetness of the first layer in combination with the less than completely hiding second layer, can provide a desirable luster, sparkle, flop index, and/or metallic color for the coating system of the present disclosure. For example, the first layer may be a primer layer and the second layer may be a base coat layer at least partially disposed over a portion of the primer layer. Thus, because the base coat layer may not be completely hiding and the first layer comprises a CIELAB L* value of no greater than 10 and/or a jetness of 350 or greater, the coating system according to the present disclosure may still maintain the desirable luster, sparkle, flop index, and/or metallic color of a comparative coating system with electrically conductive metallic effect pigments.

The first coating composition, the second coating composition, the first layer, and/or the second layer can comprise other additives and/or additional pigments. For example, the additives can comprise plasticizers, abrasion-resistant particles, film-strengthening particles, flow control agents, thixotropic agents, rheology modifiers, cellulose acetate butyrate, catalysts, antioxidants, biocides, defoamers, surfactants, wetting agents, dispersing aids, adhesion promoters, clays, hindered amine light stabilizers, ultraviolet (UV) light absorbers and stabilizers, stabilizing agents, fillers, organic cosolvents, reactive diluents, grind vehicles, and other customary auxiliaries, or a combination thereof.

The first coating composition and/or the second coating composition can be formulated as a solvent-based composition, a water-based composition, or a 100% solid (i.e., non-volatile) composition that does not comprise a volatile solvent (e.g., readily vaporizable at ambient temperatures) or aqueous carrier. In addition, the first coating composition and/or the second coating composition can be a liquid at a temperature of −10° C. or greater, such as, for example, 0° C. or greater, 10° C. or greater, 30° C. or greater, 40° C. or greater, or 50° C. or greater. The first coating composition and/or the second coating composition can be a liquid at a temperature of 60° C. or lower, such as, for example, 50° C. or lower, 40° C. or lower, 30° C. or lower, 10° C. or lower, or 0° C. or lower. The first coating composition and/or the second coating composition can be a liquid at a temperature in a range of −10° C. to 60° C., such as, for example, −10° C. to 50° C., −10° C. to 40° C., −10° C. to 30° C., or 0° C. to 40° C. The first coating composition and/or the second coating composition can be a liquid at ambient temperature (e.g., 20° C. to 25° C.).

The first coating composition and/or the second coating composition can be formulated with a liquid viscosity suitable for atomization and droplet formation under the high-shear conditions associated with single or multiple component spray application techniques at a temperature of −10° C. or greater, such as, a temperature of 0° C. or greater, a temperature of 10° C. or greater, a temperature of 30° C. or greater, a temperature of 40° C. or greater, or a temperature of 50° C. or greater. The first coating composition and/or the second coating composition can be formulated with a liquid viscosity suitable for atomization and droplet formation under the high-shear conditions associated with single or multiple component spray application techniques at a temperature of 60° C. or lower, such as, 50° C. or lower, 40° C. or lower, 30° C. or lower, 10° C. or lower, or 0° C. or lower. The first coating composition and/or the second coating composition can be formulated with a liquid viscosity suitable for atomization and droplet formation under the high-shear conditions associated with single or multiple component spray application techniques in a temperature range of −10° C. to 60° C., such as, −10° C. to 50° C., −10° C. to 40° C., −10° C. to 30° C., or 10° C. to 40° C. For example, liquid viscosity suitable for atomization and droplet formation under the high-shear conditions associated with single or multiple component spray application techniques would include a viscosity of 50-500 centipoise (cP) as measured on a Brookfield CAP2000 with a #2 spindle at 900 RPM measured at 22° C. High-shear conditions associated with single or multiple component spray application techniques can include the shear imparted by various spray application techniques including bell, spray guns including air spray, airless spray, air-assisted airless spray. Such spray application would be expected to have shear rates >1000 sec⁻¹, the exact magnitude would vary depending on the spray technique employed.

The coating system, the first layer, and/or the second layer may comprise no greater than 2 percent by weight of an electrically conductive pigment (e.g., having a bulk electrical conductivity of at least 106 S/m), such as, for example, no greater than 1 percent by weight, no greater than 0.5 percent by weight, or no greater than 0.1 percent by weight. For example, the coating system, the first layer, and/or the second layer may not comprise an electrically conductive pigment. The electrically conductive pigment can comprise electrically conductive material or comprise a dielectric substrate (e.g., an electrically insulating material having an electrical conductivity of less than 10⁻³ S/m) and an electrically conductive layer surrounding the dielectric substrate. The electrically conductive pigment can be, for example, aluminum flake, steel flake, copper flake, silver particles, conductive carbon pigments, or a combination thereof. For example, the first layer and/or second layer may comprise 2 percent or less by weight of aluminum flake, such as, for example, 1 percent or less, 0.5 percent or less, or 0.1 percent or less, by weight of aluminum flake based on the total weight of the respective layer. The aluminum flake can comprise Aluminum Paste 634A from Toyal Aluminum K.K. and/or TSB 2044A Aluminum Paste from Toyal America. Minimizing the aluminum flake in the coating system according to the present disclosure can enable higher radar transmission by the coating system.

The coating system according to the present disclosure can transmit 80% or greater of electromagnetic radiation comprising a frequency of 1 GHz to 100 GHz through the coating system, such as, for example, 85% or greater or 90% or greater of electromagnetic radiation comprising a frequency of 1 GHz to 100 GHz through the coating system. The coating system according to the present disclosure can transmit 80% or greater of electromagnetic radiation comprising a frequency of 1 GHz to 100 GHz through the coating system, such as, for example, 85% or greater or 90% or greater of electromagnetic radiation comprising a frequency of 76 GHz to 81 GHz through the coating system. The coating system according to the present disclosure can transmit 80% or greater of electromagnetic radiation comprising a frequency of 76 GHz to 81 GHz through the coating system, such as, for example, 85% or greater or 90% or greater of electromagnetic radiation comprising a frequency of 76 GHz to 81 GHz through the coating system.

One way radar transmission loss (OWRTL) can quantify the radar loss, if any, of a coating, film, and/or article incorporating the pigment according to the present disclosure. OWRTL can be measured in dB according to the Radar Test using a radar transmission system, such as, for example, a focused beam radar measurement system assembled from the following components: a signal generator (SMA100B (with SMAB-B92/SMAB-B120)) available from Rohde & Schwarz, a six times multiplier (SMZ90) available from Rohde & Schwarz, a thermal waveguide power sensor (NRP90TWG) available from Rohde & Schwarz, two E-band spot-focusing lens antennas with 1.7 inch focal length (SAQ-813017-12-S1) available from Sage Millimeter, and a Coax cable, 3.5 mm Male to 3.5 mm Male (FM160FLEX) available from Fairview Microwave. The two lenses are connected to the emitter (six times multiplier) and the detector (the power sensor), with the lenses facing each other. The lenses are aligned along their axes, with their separation being about twice their focal length (3.4 inches) and with this separation adjusted to ensure maximum free space radar transmission, with no sample between the lenses. Then, with this setup, a sample may be measured by securing it between the lenses, with the surface of the sample that is facing the detecting lens being placed at a distance of 45 mm from the detecting lens (1.8 mm in front of the focal point of the detecting lens). If the sample is a thermoplastic polyolefin (TPO) panel having a coating or film thereon, the OWRTL may be measured by securing it between the lenses, with the surface of the coating or film that is being measured placed facing the detecting lens, at a distance of 45 mm from the detecting lens. The radar transmission loss in dB is calculated with Equation 2.

$$OWRTL ( dB ) = free space transmission ( dBm ) - sample transmission ( dBm ) . \qquad Equation 2$$

A coating system, film, and/or article according to the present disclosure can comprise a desirable radar transparency. For example, a coating system, film, and/or article according to the present disclosure can comprise an OWRTL of no greater than 1.5 dB as measured by the Radar Test in the frequency range of 76 GHz to 81 GHz, such as, for example, no greater than 1.3 dB, no greater than 1.0 dB, no greater than 0.7 dB, no greater than 0.5 dB, or no greater than 0.3 dB, all as measured by the Radar Test.

The coating system according to the present disclosure can have a desirable appearance, such as luster, sparkle, flop index, and/or metallic color. For example, a coating, film, and/or article incorporating the pigment according to the present disclosure can comprise an L₁₅ value of 115 or greater as measured by the Near-Specular Lightness Test, such as, for example, 120 or greater, 125 or greater, or 130 or greater, all as measured by the Near-Specular Lightness Test.

The metallic-like color of the coating system can be quantified according to flop index. For example, the flop index of a coating system according to the present disclosure can be 19 or greater as measured according to the Flop Test, such as, for example, 20 or greater, 21 or greater, 22 or greater, 23 or greater, 24 or greater, 25 or greater, or 26 or greater, all as measured according to the Flop Test.

The flop index of the coating or film on a substrate or the article can be determined using the Flop Test. The Flop Test can quantify the flop index from the L* values using the CIELAB color space measured using a multi-angle spectrophotometer, such as, for example, a BYKmac I spectrophotometer, with D65 illumination and 10° observer. As used herein, the term “flop index” is defined according to “Observation and Measurement of the Appearance of Metallic Materials—Part 1—Macro Appearance,” C. S. McCamy, Color Research And Application, Volume 21, Number 4, August 1996, pp. 292-304, which is hereby incorporated by reference. Namely, the flop index is defined according to Equation 3, set forth below.

$$Flop Index = 2.69 ( {L}_{15} - {L}_{110} ) 1.11 / ( {L}_{45} ) 0.86 \qquad Equation 3$$

wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°.

The dry film thickness (DFT) can be chosen to provide the desired contrast ratio and the desired radar transmission. For example, increasing the DFT can increase the contrast ratio. However, increasing the DFT can also increase the OWRTL. The DFT of the coating system and/or film can be in the range of 5 μm to 100 μm. The DFT selected for the coating system should be the same used in the Contrast Ratio Test, the Near-Specular Lightness Test, the Flop Test, and the Radar test. The DFT of the coating and/or film can be measured using a coating thickness measuring tool, such as a FMP40C Dualscope (available from Fischer Technology, Inc.).

The first coating composition and/or the second coating composition, can be, for example, an automotive original equipment manufacturer coating composition, an automotive refinish coating composition, an industrial coating composition, an architectural coating composition, a coil coating composition, a packaging coating composition, a marine coating composition, an aerospace coating composition, a consumer electronic coating composition, or the like, or combinations thereof. For example, the first coating composition and/or the second coating composition can be applied to an automotive part, such as, for example, a bumper fascia, mirror housings, a fender, a hood, a trunk, a door, or the like, or an aerospace part, such as, for example, a nose cone, a radome, or the like.

A method for applying a coating system according to the present disclosure to a substrate comprises depositing a first coating composition and a second coating composition over a substrate. Each coating composition can be deposited by at least one of spray coating, spin coating, dip coating, roll coating, flow coating, and film coating. In various examples, the coating system may be manufactured as a preformed film and thereafter applied to the substrate. After depositing a coating composition over the substrate, the coating composition may be allowed to coalesce to form a continuous film on the substrate. The first coating composition can be cured to form the first layer and the second coating composition can be cured to form the second layer. The first coating composition may be cured before or simultaneously with the second coating composition. Each coating composition can be cured at a temperature of −10° C. or greater, such as, for example, 10° C. or greater. Each coating composition can be cured at a temperature of 175° C. or lower, such as, for example, 100° C. or lower. Each coating composition can be cured at a temperature in a range of −10° C. to 175° C. The curing can comprise a thermal bake (e.g., 80° C. or more, 100° C. or more, 140° C. or more) in an oven.

The flake pigments according to the present disclosure may also suitably be incorporated into a film that, when applied to an article, may provide a desirable optical property, including imparting a metallic luster across visible light wavelengths, and/or providing desirable radio frequency transparency, such as at automotive radar frequencies. The film comprising the pigments of the present disclosure can be formed from any material in which a film suitable for application to a substrate would result. Films according to the present disclosure may be made such that the film would have an appearance similar to a flake-containing coating with a “sparkle-like” quality, rather than a mirrored look. The “sparkle-like” quality evident in coatings containing reflective effect pigments can be evaluated as described in “Complete Appearance Control for Effect Paint Systems,” Paint & Coatings Industry, Mar. 8, 2020. Films can be applied to any substrate, as described herein, and may be used in conjunction with another film layer or coating layer.

The film can be a multilayer film comprising of at least three layers, including the first layer, the second layer, and an adhesive layer. The adhesive layer can be protected with a removable layer or release liner that would be removed prior to application of the film to a substrate. The first coating composition and/or second composition may be applied to a carrier film that would support the coating compositions until the coating system is formed, and thereafter the carrier film may optionally be removed. The coating system may be applied to a protective clear film that itself may be on a carrier film. The protective clear film may be thermoset or thermoplastic and would be the top layer when the multilayer film is applied to a substrate via contact of the adhesive layer with the substrate. A layer of the multilayer film may comprise thermoset or thermoplastic polyurethane. Examples of such multilayer films and the process of making such films are described in U.S. Patent Publication No. 2011/0137006, U.S. Patent Publication No. 2017/0058151, U.S. Patent Publication No. 2014/322529, U.S. Patent Publication No. 2004/0039106, U.S. Patent Publication No. 2009/0186198, U.S. Patent Publication No. 2010/0059167, U.S. Patent Publication No. 2019/0161646, U.S. Pat. Nos. 5,114,789, 5,242,751, and 5,468,532, all of which are hereby incorporated by reference. The first layer of the film may be spray applied, extruded, formed, or polymerized in situ, or otherwise deposited to an adjacent layer of a multilayer film or to a removable layer.

The substrate can be at least partially coated with the coating system according to the present disclosure. For example, the coating system can be applied to 5% or greater of an exterior surface area of the substrate, such as, for example, 10% or greater, 20% or greater, 50% or greater, 70% or greater, 90% or greater, or 99% or greater of an exterior surface area of the substrate. The coating system according to the present disclosure can be applied to 100% or lower of an exterior surface area of the substrate, such as, for example, 99% or lower, 90% or lower, 70% or lower, 50% or lower, 20% or lower, or 10% or lower of an exterior surface area of the substrate. The coating system according to the present disclosure can be applied to 5% to 100% of an exterior surface area of the substrate, such as, for example, 5% to 99%, 5% to 90%, 5% to 70%, or 50% to 100% of an exterior surface area of the substrate.

The coating system may be incorporated into a multilayer coating stack, such as a multilayer coating stack including at least three coating layers, a first layer, a second layer over at least a portion of the first layer, and a third layer. Additional layers, such as, for example, a pretreatment layer, an adhesion promoter layer, a basecoat layer, a mid-coat layer, a topcoat layer (e.g., clear coat, tinted clear coat), a primer layer (e.g., a non-conductive primer layer), or combinations thereof, may be deposited before or after the coating system according to the present disclosure. The tinted clear coat can be, for example, a clear coat to which dyes and or pigments are added, including the nano-sized pigment dispersions described in U.S. Pat. Nos. 6,875,800, 7,605,194, 7,612,124, and 7,981,505, all of which are hereby incorporated by reference herein. The tinted clear coat can comprise nano-sized pigment dispersions with an average primary particle size of less than 150 nm as measured with a transmission electron microscope (TEM), such as, for example, less than 100 nm as measured with a TEM. The nano-sized pigment dispersions can have an average primary particle size in a range of 20 nm to 150 nm, such as, for example, 20 nm to 100 nm, 20 nm to 80 nm, 20 nm to 60 nm, or 20 nm to 40 nm. For example, the nano-sized pigments dispersions can have an average primary particle size of 25 nm, 35 nm, or 50 nm.

A coating stack for use in automotive applications may comprise an adhesion promoter layer applied to a radar transmissive substrate, a primer layer (e.g., first layer) disposed over the adhesion promoter layer, a basecoat layer (e.g., second layer) disposed over the primer layer, and a clear coat disposed over the basecoat layer.

The coating system and/or film of the present disclosure can be applied to various substrates in which radar transparency and metallic appearance may be desired. For example, the substrate upon which the coating system and/or film of the present disclosure may be applied comprise an automotive substrate, an industrial substrate, an architectural substrate, a coil substrate, a packaging substrate, a marine substrate, an aerospace substrate, a consumer electronic device substrate (e.g., a phone, computer, tablet), or the like, or combinations thereof. “Automotive” as used herein refers to in its broadest sense all types of vehicles, such as, but not limited to, cars, trucks, buses, tractors, harvesters, heavy duty equipment, vans, golf carts, motorcycles, bicycles, railcars, airplanes, helicopters, boats of all sizes, and the like.

The substrate can be a radar transmissive substrate such as a non-metallic substrate. Non-metallic substrates may include polymeric, such as plastic, including polyester, polyolefin, polyamide, cellulosic, polystyrene, polyacrylic, poly(ethylene naphthalate), polypropylene, polyethylene, nylon, ethylene vinyl alcohol, polylactic acid, other “green” polymeric substrates, poly(ethyleneterephthalate), polycarbonate, polycarbonate acrylobutadiene styrene, or polyamide. The substrate can comprise at least a portion of an automotive component. Also provided herein is an automotive component at least partially coated with at least a portion of the coating system and/or a film according to the present disclosure.

A “radar transmissive substrate” means a substrate having a composition and thickness suitable to transmit electromagnetic radiation at various radar frequencies (e.g., in the range of automotive frequencies of 76 GHz to 81 GHz) with minimal, if any, transmission loss. For example, a radar transmissive substrate can be transparent to the various radar frequencies. That is, a radar transmissive substrate can have a OWRTL of no greater than 5 dB as measured by the Radar Test described below. Radar transmissive substrates may be nonmetallic and include polymeric substrates, such as plastic, including polyester, polyolefin, polyamide, cellulosic, polystyrene, polyethylene terephthalate, polyacrylic, poly(ethylene naphthalate), polypropylene, polyethylene, nylon, ethylene vinyl alcohol, polylactic acid, other “green” polymeric substrates, poly(ethyleneterephthalate), polycarbonate, polycarbonate acrylobutadiene styrene, polyurethane, thermoplastic olefins, polyamide, or combinations thereof. The radar transmissive substrate may be filled or unfilled plastic. A filled plastic comprises a plastic with additives such as, for example, fibers, glass fibers, and/or particles, such as talc. The radar transmissive substrate can comprise glass, wood, or a combination thereof.

A coating stack as applied to a radar transmissive substrate, such as, for example, in automotive refinish or aerospace applications, may comprise an optional pretreatment layer and/or adhesion promoter layer, a primer layer, a basecoat layer, and a clear coat. A coating stack as applied to a radar transmissive substrate, such as, for example, in automotive refinish, general industrial, or aerospace applications, can comprise an optional pretreatment or adhesion promoter layer, a primer layer, and a direct gloss topcoat layer. Direct gloss topcoat means a coating layer comprising both the color (e.g., flake pigment) and gloss in one coating layer that is typically the last applied coating of a coating stack. An additional clear coat can be applied to a direct gloss coating.

The coating system and/or film according to the present disclosure may also be suitably incorporated into an article of manufacture, such as, for example, an article formed by injection molding, or an additive manufacturing process, such as, for example, a 3D-printing process. In this manner, the coating system and/or film can be applied to automotive parts, aerospace parts, consumer electronic parts, and the like. Such parts would be expected to have a “sparkle-like” or metallic appearance while also facilitating radar transmission. For example, an automotive part can comprise bumper fascia, mirror housings, a fender, a hood, a trunk, a door, and the like. Aerospace parts can comprise a nose cone and a radome.

In-mold coating (IMC) is an alternative to painting for injection molded plastic parts. IMC can be done by injecting the first coating composition and the second coating composition according to the present disclosure onto the surface of the article of manufacture while it is still in the mold. Each coating composition then solidifies and adheres to the article. A coating system or film according to the present disclosure can be applied in the mold prior to injection molding of an article of manufacture such that the coating or film is applied to the surface of the molded article or manufacture. Both methods are IMC according to the present disclosure.

The coating compositions and films according to the present disclosure, when coated on substrates to form a coating layer or applied to substrates as a film, may result in substrates having favorable radar transmission performance and desirable aesthetics.

When a radar system is positioned proximal and/or adjacent to the coating system and/or the film, and/or the article incorporating the coating system and/or film of the present disclosure, the radar system can transmit electromagnetic waves that can efficiently and effectively traverse through the coating system, film, and/or article. Minimal, if any, radar transmission loss occurs through the coating system, film, and/or article provided in the present disclosure. Prior art coating systems that wholly incorporate electrically conductive metallic effect pigments have an electrical resistivity significantly lower than the flake pigment of the present disclosure that can result in a high radar transmission loss. Because the coating system according to the present disclosure substantially comprises radar transmissive pigment, the coating system can enable the efficient transmission of electromagnetic radiation, including radar frequency wavelengths, such that the electromagnetic radiation can exit the coating system with minimal, if any, loss in the electromagnetic wave transmission. The electromagnetic radiation that exits the coating, film, and/or article can be used for the detection of an object. For example, the electromagnetic radiation can reflect off the object and return through the coating system, film, and/or article and be detected by the radar system.

A method for improving radio detection and ranging in the electromagnetic radiation frequency range of 1 GHz to 300 GHz, such as, 1 GHz to 100 GHz or 76 GHz to 81 GHz, with radar sensors that are mounted behind metallic effect-coated articles is provided comparative to a substrate coated with a coating system comprising aluminum flake. The method comprises applying a coating system according to the present disclosure to a substrate, such as, for example, an automotive substrate.

As used herein, unless otherwise expressly specified, all numbers, such as those expressing values, ranges, amounts, or percentages, may be read as if prefaced by the word “about,” even if the term does not expressly appear. Any numerical range recited herein is intended to include all sub-ranges subsumed therein. The plural encompasses the singular and vice versa. For example, while the invention has been described in terms of “a” pigment, “a” substrate, “a composite layer”, “a radar transmissive pigment”, “a primer layer”, “a base coat layer”, and the like, more than one of these and other components, including mixtures, can be used.

Also, as used herein, the term “polymer” is meant to refer to prepolymers, oligomers, and both homopolymers and copolymers; and the prefix “poly” refers to two or more. When ranges are given, any endpoints of those ranges and/or numbers within those ranges can be combined with the scope of the present invention. “Including,” “such as,” “for example,” and like terms mean “including/such as/for example but not limited to.” The terms “acrylic” and “acrylate” are used interchangeably (unless to do so would alter the intended meaning) and include acrylic acids, anhydrides, and derivatives thereof, lower alkyl-substituted acrylic acids, e.g., C1-C2 substituted acrylic acids, such as, for example, methacrylic acid, ethacrylic acid, etc., and their C1-C6 alkyl esters and hydroxyalkyl esters, unless clearly indicated otherwise.

As used herein, the terms “on,” “applied on/over,” “formed on/over,” “deposited on/over,” “overlay,” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

As used in this specification, the terms “cure” and “curing” refer to the chemical crosslinking of components in a coating composition applied as a coating layer over a substrate. Accordingly, the terms “cure” and “curing” do not encompass solely physical drying of coating compositions through solvent or carrier evaporation. In this regard, the term “cured,” as used in this specification, refers to the condition of a coating layer in which a component of the coating composition forming the layer has chemically reacted to form new covalent bonds in the coating layer (e.g., new covalent bonds formed between a binder resin and a curing agent).

As used in this specification, the term “formed” refers to the creation of an object from a composition by a suitable process, such as, curing. For example, a coating formed from a curable coating composition refers to the creation of a single or multiple layered coating or coated article from the curable coating composition by curing the coating composition under suitable process conditions.

### EXAMPLES

The present disclosure will be more fully understood by reference to the following examples, which provide illustrative non-limiting aspects of the disclosure. It is understood that the disclosure is not necessarily limited to the examples described in this section.

As used herein, the term “parts” refers to parts by weight unless indicated to the contrary.

Notwithstanding that the numerical ranges and parameters setting forth the broad scope of the invention are approximations, numerical values set forth in the specific examples are reported as precisely as possible. Any numerical value, however, inherently contains certain errors necessarily resulting from the standard variation found in their respective testing measurements.

Whereas particular examples of this disclosure have been described above for purposes of illustration, it will be evident to those skilled in the art that numerous variations of the details of the present disclosure may be made without departing from the disclosure as defined in the appended claims.

A BYKmac I multi-angle spectrophotometer was used per the manufacturer's directions to measure multi-angle color data including L* values at various angles with D65 illumination and 10° observer. The reported L* values in the Examples are the average of three measurements.

Effect pigment formulations used as a basecoat were prepared by combining DBC500 with the desired pigment(s) as listed below in Table 1. DBC500 and the pigment were combined and stirred by hand for approximately 3 minutes, then DT885 was added and shaken for approximately 2 minutes.

TABLE 1
Effect pigment formulations for the second layer

| Formulation | A | B | C |
|---|---|---|---|
| DBC500^{a} | 121.71 | 121.7 | 121.7 |
| TCR3040^{b} | 9.36 | 0 | 0 |
| Lumina Exterior | 0 | 8.45 | 7.40 |
| Pearl Radiance | | | |
| 1303D^{c} | | | |
| Iriodin 9602 Silver- | 0 | 1.49 | 2.47 |
| Grey SW^{d} | | | |
| DT885^{e} | 120.18 | 120.70 | 120.65 |
| Pigment Volume | 11.1 | 11.1 | 11.0 |
| Concentration | | | |
| (PVC) | | | |

^{a}DELTRON Color Blender comprising cellulose acetate butyrate and polyacrylate available from PPG Industries, Inc.
^{b}Aluminum pigment paste available from Toyal
^{c}Electrically non-conductive mica pigment available from BASF Colors & Effects
^{d}Electrically non-conductive mica pigment available from Merck KGaA, Darmstadt, Germany
^{e}DELTRON Warm Temperature Reducer available from PPG Industries, Inc.

Coating compositions were formulated according to formulations A-C in Table 1 and sprayed in one or more coats to a DFT of 0.5-2.0 mils (12-50 microns) onto a TPO substrate (Lyondell Basell HiFax TRC779X, 4×12×0.118 inch, available from Standard Plaque Inc. Melvindale, MI) to form the second layer on top of the first layer (e.g., gray first layer or black first layer). Additionally, the coating compositions were sprayed onto a black/white Metopac panel 3×5× 3/16 inch, Form T12G, from Leneta Company, as needed when measuring opacity. Prior to spraying the TPO panels with the coating compositions according to formulations A-C in Table 1, the TPO panels were cleaned with SU4901 Clean and Scuff Pad, wiped with SU4902 Plastic Adhesion Wipe, and sprayed with SUA4903 Advanced Plastic Bond (all available from PPG Industries, Inc.). Then DAS3025 gray acrylic urethane sealer was combined with DCX3030 Undercoat Hardener and DT885 Warm Temperature 75-90° F. (24-32° C.) reducer (all available from PPG Industries, Inc.) and was applied using a SATAjet BF100 spray gun with a 1.3 mm nozzle and 28 psi (1.9 bar) air pressure at the gun to a target DFT of 0.8-1.0 mil (20-25 microns). The DAS3025 sealer was allowed to dry/cure at ambient conditions for 15-60 minutes before the next coating was applied. The coating compositions according to formulations A-C in Table 1 were applied over the DAS3025 when a gray under layer (e.g., first layer) was being considered. In instances where a black under layer (e.g., first layer) was desired, DBC9700 DELTRON basecoat black (available from PPG Industries, Inc.) was combined with DT885 at 2:1 volume ratio and spray applied to the DAS3025 sealer in two coats using a SATAjet 1500 B high volume low pressure (HVLP) SoLV with a 1.3 mm nozzle and 28 psi (1.9 bar) air pressure at the gun. Once applied, the DBC9700 layer was allowed to flash (e.g., to remain at ambient temperature and allow for evaporation of some of the volatile content of a coating) for 15 minutes before the effect pigment formulation was applied. In instances where a dark gray layer (e.g., first layer) was desired, a 71 w % DMD1683/29w % DMD1684 mixture (DELTRON basecoat available from PPG Industries, Inc.) was combined with DT885 at 1:1 volume of DMD mixture to DT885 and spray applied over the DAS3025 sealer in two coats using a SATAjet 1500 B HVLP SOLV with a 1.3 mm nozzle and 28 psi (1.9 bar) air pressure at the gun. Once applied the DMD mixture layer was allowed to flash for 15 minutes before the effect pigment formulation was applied.

Formulations A-C from Table 1 were agitated prior to spray application by stirring and a SATAjet 1500 B HVLP SoLV with a 1.3 mm nozzle and 28 psi air pressure (1.9 bar) at the gun was used to spray apply the coatings to previously applied over gray panels (DAS3025 was the previously applied coating), dark gray panels (DMD1683/DMD1684 mixture was the previously applied coating) and black panels (DBC9700 was the previously applied coating) with flash between multiple coats for 5-10 minutes and were considered dry when the coatings were tack free (e.g., a condition of a coating where its surface ceases to be sticky) (typically 15-20 minutes at 20° C.). The black/white Metopac panels were also coated in the same way with the effect pigment formulations from Table 1 by spraying the formulations directly to the black/white Metopac panel.

Lastly, the TPO and black/white Metopac panels were coated with a protective clearcoat. PPG DELTRON solvent borne clearcoat (Velocity Premium Clearcoat; DC 4000) was prepared by mixing DC 4000 with hardener (DCH 3085) in a 4:1 v/v ratio. The mixtures were agitated prior to spray application by stirring. Clearcoat was applied in two coats over the effect pigment formulations from Table 1 on both substrates using a HVLP gravity fed spray gun (Iwata WS400) with a 1.3 mm nozzle and 28 psi (1.9 bar) at the gun. Clearcoats were applied using two coats with a 5-10 minute flash at ambient temperature between coats. Clearcoats were cured as described in the publicly available technical data sheet, such as in a convection oven at 60° C. for 20 minutes or at 21° C. for 4-6 hours. All DFTs were measured by spraying 0.020×2×12 inch steel film check panels (available from Q-Lab Corporation, Westlake, Ohio, Order Number SP-105293) at the same time as the other panels and using a FMP40C Dualscope (available from Fischer Technology, Inc.) coating thickness measuring tool to measure the cured coating thickness on the film check panels.

### Effect Pigment Formulations Applied to a Black/White Metopac Panel

Formulations B and C were applied to a black/white Metopac panel and topcoated with DC 4000 clear coat as described above. Table 2 summarizes the observed data.

TABLE 2
Observations from Formulations B and C as applied to a black/white Metopac panel.

| | | | | | Contrast | | |
|---|---|---|---|---|---|---|---|
| | | | | L* | Ratio of the | | |
| | Formulation | Formulation | Under | SCE of | coating layer | | |
| | of Second | DFT (mil) | layer | under | formed from | Flop | |
| Example | Layer | ((microns)) | color¹ | layer | formulation C² | Index | L₁₅ |
| Comparative 1 | B | 0.41 (10.4) | White | 91.7 | 0.33 | 8.8 | 139 |
| Inventive 2 | B | 0.41 (10.4) | Black | 5.7 | 0.33 | 19.4 | 132 |
| Comparative 3 | C | 0.42 (10.7) | White | 91.7 | 0.33 | 9.8 | 135 |
| Inventive 4 | C | 0.42 (10.7) | Black | 5.7 | 0.33 | 20.5 | 131 |

¹black or white section of black/white Metopac panel 3 × 5 × 3/16 inch, Form T12G, from Leneta Company
²measured according to the Contrast Ratio Test

Formulation B has a flop of only 8.8 when measured over white underlayer (Comparative Example 1) but a flop of 19.4 when measured over black underlayer (Inventive Example 2). Formulation C has a flop of only 9.8 when measured over white underlayer (Comparative Example 3) but a flop of 20.5 when measured over black underlayer (Inventive Example 4). It can be seen that a combination of a dark color underlayer and a contrast ratio <0.98 of the second layer contribute to desired flop measurements ≥19.

### Effect Pigment Formulations Applied Over Gray or Black Undercoat

Formulations A-C were spray applied over gray, dark gray, and/or black undercoats as described above. Table 3 summarizes the observed data below.

TABLE 3
Observations from Formulations A-C as applied to TPO and black/white Metopac panel.

| | | | | L* | | | | | |
|---|---|---|---|---|---|---|---|---|---|
| | | Formulation | Under | SCE of | | | | | |
| | | DFT (mil) | layer | under | Flop | Contrast | | OWRTL | |
| Example | Formulation | ((microns)) | color¹ | layer | Index | Ratio² | L₁₅ | (dB) | % T |
| Comparative 5 | A | 1.06 (26.9) | Gray | 67.9 | 17.9 | 1.00 | 147 | 2.21 | 60 |
| Comparative 6 | A | 1.06 (26.9) | Black | 1.0 | 18.0 | 1.00 | 146 | 2.15 | 61 |
| Comparative 7 | B | 0.41 (10.4) | Gray | 64.3 | 12.1 | 0.33 | 132 | 0.63 | 87 |
| Comparative 8 | B | 0.41 (10.4) | Dark | 24.0 | 18.2 | 0.33 | 130 | 0.71 | 85 |
| 10 | | | Gray | | | | | | |
| Inventive 9 | B | 0.44 (11.2) | Black | 1.0 | 19.5 | 0.33 | 131 | 0.66 | 86 |
| Comparative 10 | C | 0.43 | Gray | 64.3 | 12.1 | 0.33 | 129 | 0.74 | 84 |
| Comparative 11 | C | 0.43 | Dark | 24.0 | 17.4 | 0.33 | 128 | 0.69 | 85 |
| | | | Gray | | | | | | |
| Inventive 12 | C | 0.42 | Black | 1.0 | 19.5 | 0.33 | 127 | 0.70 | 85 |

¹Gray: DAS3025 sealer was layer that the effect pigment formulation was applied over; Black: DBC9700 basecoat black was layer that the effect pigment formulation was applied over; Dark Gray: 71 w % DMD1683/29 w % DMD1684 basecoat mixture was layer that the effect pigment formulation was applied over
²measured according to the Contrast Ratio Test

Comparative Examples 5 and 6 use Formulation A which contains aluminum flake pigments. This pigment is electrically conductive and substantially reduces the radar transmission through the coating but does provide a reasonable L₁₅ and Flop Index comparison. For example, Comparative Examples 5 and 6 have a percent radar transmission of 60.2 and 61.0, respectively, which is not desirable for use in radar applications. Note that since Comparative Examples 5 and 6 have a 1.0 Contrast Ratio the observed Flop Index is similar regardless of the under-layer L*SCE value.

Comparative Examples 7 and 8 and Inventive Example 9 use Formulation B and differ only in the under-layer color. When the under-layer color is changed from gray to dark gray to black the observed Flop Index increases from 12.1 to 18.2 to 19.5, respectively. Additionally, it can be seen that the % radar transmission is similar for Comparative Examples 7 and 8 and Inventive Example 9 with all having greater than 80% radar transmission.

Comparative Examples 10 and 11 and Inventive Example 12 use Formulation C and differ only in the under-layer color. When the under-layer color is changed from gray to dark gray to black the observed Flop Index increases from 12.1 to 17.4 to 19.5, respectively. Additionally, it can be seen that the % radar transmission is similar for Comparative Examples 10 and 11 and Inventive Example 12 with all having greater than 80% radar transmission.

The above examples demonstrate the use of a coating system comprising a dark first layer with an L* SCE of no greater than 10 and a subsequent second layer comprising a flake pigment wherein the contrast ratio of the second layer is no greater than 0.80 can achieve a Flop Index of 19 or greater and a percent radar transmission of 80% or greater.

The term “average” as used herein means a “mean” of any variable, x, such as wavelength, diameter, lateral size, thickness, and so forth, is calculated by the equation: average=(1/N)Σxi, where N values of the variable x are being averaged, such that i=1 to N, and Σxi=x1+x2+ . . . +xN, as discussed in Data Reduction and Error Analysis for the Physical Sciences, 2nd edition, 1992, pages, 8-9, by Philip R. Bevington and D. Keith Robinson, ISBN 0-07-911243-9.

Various features and characteristics are described in this specification to provide an understanding of the composition, structure, production, function, and/or operation of the disclosure, which includes the disclosed compositions, coatings, and methods. It is understood that the various features and characteristics of the disclosure can be combined in any suitable manner, regardless of whether such features and characteristics are expressly described in combination in this specification. The Inventors and the Applicant expressly intend such combinations of features and characteristics to be included within the scope of the disclosure. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

While the present disclosure provides descriptions of various specific aspects for the purpose of illustrating various aspects of the present disclosure and/or its potential applications, it is understood that variations and modifications will occur to those skilled in the art. Accordingly, the disclosure should be understood to be at least as broad as claimed and not as more narrowly defined by particular illustrative aspects provided herein.

1. A coating system comprising:
a first layer comprising
a first film-forming resin; and
a first pigment,
wherein a CIELAB L* value of the first layer is no greater than 10 as measured with an integrating sphere spectrophotometer with D65 Illumination, 10° observer, and specular component excluded; and
a second layer disposed over at least a portion of the first layer, the second layer comprising:
a second film-forming resin, which is the same or different as the first film-forming resin; and
a flake pigment,
wherein a contrast ratio of the second layer is no greater than 0.80 as measured according to the Contrast Ratio Test using an integrating sphere spectrophotometer with D65 illumination, 10° observer, and specular component included
wherein the coating system has a flop index of 19 or greater as measured using a multi-angle spectrophotometer, with D65 illumination and 10° observer according to the following equation:
$$Flop Index = 2.69 {( {L}_{15} - {L}_{110} )}^{1.11} / {( {L}_{45} )}^{0.86}$$
wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°.

2. The coating system of claim 1, wherein the second layer comprises 2% or less by weight of aluminum flake based on the total weight of the second layer.

3. The coating system of claim 1, wherein the flake pigment comprises a mica pigment, an oxide coated mica pigment, a glass flake, an oxide coated glass flake, a visible light diffractive pigment, a visible light reflective organic pigment, a metal oxide platelet, a radar transmissive composite pigment, or a combination thereof.

4. The coating system of claim 1, wherein the first pigment comprises, carbon black, iron oxide, perylene black, Pigment Blue 15:1, Pigment Blue 15:3, Pigment Brown 25, Pigment Red 101, Pigment Red 179, Pigment Red 202, Pigment Red 257, Pigment Red 264, Pigment Violet 19, Pigment Violet 29, Pigment Yellow 129, Pigment Yellow 139, Pigment 150, Pigment yellow 42, or a combination thereof.

5. The coating system of claim 1, wherein the first pigment comprises a nano-sized pigments having an average primary particle size of less than 100 nm.

6. The coating system of claim 1, wherein the first pigment comprises haze of no greater than 5% as measured according to ASTM D1003.

7. The coating system of claim 1, wherein the coating system transmits 80% or greater of electromagnetic radiation comprising a frequency of 1 GHz to 300 GHz.

8. The coating system of claim 7, wherein the first layer, the second layer, or a combination thereof comprise a dry film thickness in a range of 5 μm to 100 μm.

9. The coating system of claim 1, wherein an L₁₅ of the coating system is 115 or greater.

10. The coating system of claim 1, wherein the first layer has a jetness of 350 or greater as measured at 110°, using a multi-angle spectrophotometer, with D65 illumination and 10° observer.

11. The coating system of claim 1 wherein the first layer, the second layer, or a combination thereof, further comprise an additional pigment, a plasticizer, an abrasion-resistant particle, a film-strengthening particle, a flow control agent, a thixotropic agent, a rheology modifier, cellulose acetate butyrate, a catalyst, an antioxidant, a biocide, a defoamer, a surfactant, a wetting agent, a dispersing aid, an adhesion promoter, a clay, a hindered amine light stabilizer, an ultraviolet light absorber and/or stabilizer, a stabilizing agent, a filler, an organic cosolvent, water, a reactive diluent, a grind vehicle, or a combination thereof.

12. The coating system of claim 1, further comprising a pretreatment layer, an adhesion promoter layer, a basecoat layer, a mid-coat layer, a topcoat layer, a primer layer, or a combination thereof.

13. The coating system of claim 1, wherein the first layer is a primer layer and the second layer is a base coat layer.

14. A film comprising and/or formed from the coating system of claim 1.

15. An article comprising a coating system of claim 1 deposited over a substrate.

16. The article of claim 15, wherein the substrate comprises an automotive substrate, an industrial substrate, an architectural substrate, a coil substrate, a packaging substrate, a marine substrate, an aerospace substrate, a consumer electronic device substrate, or combinations thereof.

17. The article of claim 1, wherein the substrate comprises a bumper fascia, a mirror housing, a fender, a hood, a trunk, a door, or a combination thereof.

18. The article of claim 1, wherein the substrate is radar transmissive.

19. An automotive component coated with at least a portion of the coating system of claim 1.

20. A method for improving radio detection and ranging in an electromagnetic radiation frequency range of 1 GHz to 300 GHz with radar sensors that are mounted behind metallic effect-coated articles, the method comprising:
applying a coating system of claim 1 to an automotive substrate.
